(19) United States
(12) Patent Application Publication
(10) Pub. No.: US 2009/0272471 A1
(43) Pub. Date: Nov. 5, 2009

(54) SYSTEM FOR BALANCING A TIRE

(76) Inventor: Rene Louis Bormann, Moesdorf (LU)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/111,992

(22) Filed: Apr. 30, 2008

(51) Int. Cl. B60C 19/00; B32B 37/00

(52) U.S. Cl. 152/154.1; 156/75

(57) ABSTRACT

The present invention is directed to a machine for balancing a pneumatic tire/wheel assembly and the balanced pneumatic tire. The pneumatic tire comprises an axis of rotation, a belt structure, an innerliner disposed radially inward of the belt structure, and two annular beads for securing the tire to a wheel. The tire includes an annular spacer structure and a thixotropic gel. The annular spacer structure is attached to the innerliner and is disposed radially inward of the belt structure. The annular spacer structure defines two interior circumferential grooves between axially outer sides of the annular spacer structure and portions of the innerliner extending radially inward toward the corresponding beads of the tire. The thixotropic gel is disposed within the circumferential grooves thereby defining two circumferential gel rings. The gel of each circumferential gel ring automatically, upon rotation of the tire, flows until no more forces, except direct centripedal forces, act on the gel such that the tire is rotationally balanced.

### FIELD OF THE INVENTION

The present invention is directed to a system for balancing a tire. More specifically, the present invention is directed to a system for automatically balancing a tire.

### BACKGROUND OF THE INVENTION

The history of the wheel dates back almost six thousand years to approximately 3500 BC. However, even though the wheel has been around for centuries, the invention of the tire came thousands of years later. Over the course of time, the majority of wheels had been made of wood which guaranteed a rough ride, poor construction, and poor maintenance to go along with it.

The evolution of the wheel was very simple. The wheel was constructed of a solid, curved piece of wood, and then leather was eventually added to soften the ride. As time progressed, it became solid rubber which lead to today's tires, the pneumatic or air inflated, radial tire.

Early wheels were made of metal or wood, but were not very durable and not very comfortable in their ride. The first type of tire was really just a metal loop. Today, tires are much more durable, flexible, and more reliable than the tires from just fifty years ago. More importantly, today's tires provide much more comfort than the wood or metal hoop type wheels that came before the modern tire.

Rubber, as a foundation of the tire, has evolved significantly as well. Early rubber did not hold shape, nor was it nearly as durable and long-lasting as it is today. Early rubber was very sticky in hot weather and became inflexible when it was subjected to cold weather. Rubber would fall apart and/or snap if the temperature conditions were not appropriate or ideal. In the 1800s, Charles Goodyear was credited with discovering the vulcanization process. Vulcanization is the process of heating rubber with sulfur, which transforms sticky raw rubber into a pliable material that makes rubber a much better candidate for tire material.

Early rubber tires were constructed from solid rubber. These tires were strong, absorbed shocks, and resisted cuts and abrasions. However, solid rubber tires were heavy, expensive, and did not provide a smooth ride. Even today, some types of tires are constructed of solid rubber, thereby resisting cuts and abrasions.

The next advancement in the tire industry was the development of a pneumatic rubber tire. A pneumatic rubber tire uses rubber and enclosed air to reduce vibration and improve traction. The lighter pneumatic tire provides a much better ride quality, is much lighter, and is less expensive to produce than solid rubber tires.

For much of the early twentieth century, most vehicle tires comprised an inner tube that contained compressed air and an outer casing. Plies were made of rubberized fabric cords embedded in the rubber. These tires were known as bias-ply tires. These tires were termed “bias ply” because the cords in a single ply ran diagonally from the beads on one inner rim to the beads on the other with the cords reversed from ply to ply in a crisscross arrangement. Many of today's classic and/or antique vehicles still use bias-ply tires, as do many off-road vehicles.

Steel-belted radial tires were introduced in the mid-twentieth century. Radial tires are so named because the ply cords radiate at a 90 degree angle from the wheel rim, and the casing is strengthened by a belt of steel fabric that runs around the circumference of the tire. Radial tires typically have ply cords of nylon, rayon, or polyester. Radial tires typically have longer tread life, better steering, and less rolling resistance, which may increase gas mileage of a vehicle. On the other hand, radial tires have a stiffer riding quality and are typically very expensive compared to other types of tires.

One disadvantage of tires mounted to a wheel is that the tire can become imbalanced. This imbalance may be caused by a plurality of different factors including uneven wear, driving style, road conditions, weight, camber, and others. The imbalance of a tire may cause improper ride quality and can eventually lead to tire blowout. Properly balancing a tire requires that the tire and wheel assembly be removed from the vehicle and a specific machine be used to determine if the tire is properly balanced on the wheel. Conventionally, if a tire is improperly balanced, a weight mechanism is attached at an attachment point between the tire and the wheel. The weight mechanism is typically a small metal attachment that is attached to the wheel assembly at a specific point to counteract the imbalance. When a sufficient amount of weight has been applied to the tire/wheel assembly, the tire/wheel assembly may be remounted on the vehicle and normal driving of the vehicle may continue.

Thus, a need therefore exists for an improved system for balancing a tire that does not require the addition of elements, such as the weight mechanism, to the tire/wheel for proper balancing of the tire. The present invention satisfies this need and provides further advantages, as well.

Another conventional system utilizes a free-flowing balancing material, such as glycol and fibres, within the imbalanced tire. The material may be introduced at mounting of a tire on a rim or into an already mounted tire. The tire retains proper balance because the free-flowing material, specifically the minuscule individual elements making up the free-flowing material, inside the tire are distributed by centripetal forces generated by rotation of the wheel/tire in such a way that the free-flowing material balances a heavy spot or a heavy side of the tire assembly.

For example, a heavy spot creates a force away from the axis of rotation, but because it is anchored by the axle, an opposite force is created within the tire. This opposite force draws a sufficient quantity of the balancing material in the direction of the opposite force until the heavy spot is neutralized, or balanced about the axis of rotation. The remaining balancing material spreads itself evenly around the inside of the tire and remains in place, held by the centripetal forces which press the material against the innerliner of the tire. When the vehicle stops and the tire stops rotating, the conventional balancing material falls away from its neutralizing position on the innerliner and falls to the bottom of the tire. When the tire begins rotation again, the balancing material returns to a neutralizing position. Therefore, the process of re-balancing recommences after every stop, and a certain vibration will be felt in the vehicle before the rebalancing is completed.

Further, the constant “on the innerliner” and “off the innerliner” motion of conventional balancing material causes deterioration through this constant “on-off” motion (i.e., transformation into dust particles). This deterioration thereby causes mounting and dismounting problems for tire installers as the resulting dust deposits a coating on the wheel and the tire mounting surface. The dust may also clog the tire valve thereby possibly causing an air leak. As a result, even with a non-deteriorated balancing material, a constantly balanced tire is not produced since re-balancing must occur after every stop. During the time the material is relocating to or from the balanced positions, the tire is out of balance and vibrating. Additionally, the conventional balancing material may be abrasive in nature, causing undesirable wear of the innerliner the tire.

Conventional balancing materials may also absorb moisture, which causes clumping together of portions of the material. Thus, the clumped conventional materials tend not to move to adequate neutralizing/counterbalancing positions, or to only partially move into the optimal positions (i.e., the material cannot easily divide out or flow for proper balancing).

### SUMMARY OF THE INVENTION

One aspect of the present invention is directed to pneumatic tire comprising an axis of rotation, a belt structure, an innerliner disposed radially inward of the belt structure, and two annular beads for securing the tire to a wheel. The tire includes an annular spacer structure and a thixotropic gel. The annular spacer structure is attached to the innerliner and is disposed radially inward of the belt structure. The annular spacer structure defines two interior circumferential grooves between axially outer sides of the annular spacer structure and portions of the innerliner extending radially inward toward the corresponding beads of the tire. The thixotropic gel is disposed within the circumferential grooves thereby defining two circumferential gel rings. The gel of each circumferential gel ring automatically, upon rotation of the tire, flows until no more forces, except direct centripedal forces, act on the gel such that the tire is rotationally balanced.

Another aspect of the pneumatic tire of the present invention is that the annular spacer structure comprises two annular ribs attached to a radially inner surface of the innerliner.

Another aspect of the pneumatic tire of the present invention is that the annular spacer structure comprises two ribs having triangular cross-sections.

Another aspect of the pneumatic tire of the present invention is that the annular spacer structure comprises two separate ribs each having a slanted axially outer side partially defining each of the two circumferential grooves.

Another aspect of the pneumatic tire of the present invention is that the annular spacer structure comprises an annular spacer component disposed between the belt structure and the innerliner.

Another aspect of the pneumatic tire of the present invention is that the annular spacer structure has two axially opposite and tapered edge portions.

Another aspect of the pneumatic tire of the present invention is that the annular spacer structure comprises an annular ring component attached to a radially inner surface of the innerliner.

Another aspect of the pneumatic tire of the present invention is that the annular spacer structure comprises an annular ring component having a rectangular cross-section. The annular ring component extends axially between the axially outer sides of the annular spacer structure.

Another aspect of the present invention is directed to a method for balancing a pneumatic tire with an axis of rotation. The method comprises the steps of: securing an annular spacer structure adjacent an innerliner of the tire at a position radially inward of a belt structure of the tire; defining two interior circumferential grooves between axially outer sides of the annular spacer structure and portions of the innerliner extending radially inward toward corresponding beads of the tire; applying a thixotropic gel within the circumferential grooves thereby defining two circumferential gel rings; and rotating the tire such that the gel of each circumferential gel ring automatically flows until no more forces, except direct centripedal forces, act on the gel and the tire is rotationally balanced.

Another aspect of the method of the present invention includes the step of attaching two annular ribs to a radially inner surface of the innerliner.

Another aspect of the method of the present invention includes the step of providing the annular spacer structure with two separate ribs each having a slanted axially outer side partially defining each of the two circumferential grooves.

Another aspect of the method of the present invention includes the step of positioning an annular spacer component between the belt structure and the innerliner.

Another aspect of the method of the present invention includes the step of attaching an annular ring component to a radially inner surface of the innerliner.

Another aspect of the present invention is directed to a system for automatically balancing a pneumatic tire upon rotation of the tire about an axis of rotation. The system comprises an annular spacer structure and a thixotropic gel. The annular spacer structure is secured to an innerliner of the tire at a position radially inward of a belt structure of the tire. The annular spacer structure defines two interior circumferential grooves between axially outer sides of the annular spacer structure and portions of an innerliner extending radially inward toward corresponding beads of the tire. The thixotropic gel is disposed within the circumferential grooves thereby defining two circumferential gel rings. The gel of each circumferential gel ring automatically flows in any direction of force until no more forces, except direct centripedal forces, act on the gel and the tire is rotationally balanced.

Another aspect of the system of the present invention includes an annular ring component attached to a radially inner surface of the innerliner.

Another aspect of the system of the present invention includes two ribs having triangular cross-sections.

Another aspect of the system of the present invention includes two axially opposite and tapered edge portions partially defining the circumferential grooves.

Another aspect of the system of the present invention includes an annular ring component having a rectangular cross-section, the annular ring component extending axially between the axially outer sides of the annular spacer structure.

Another aspect of the present invention is directed to a system for automatically balancing a vehicle wheel assembly upon rotation of the assembly about an axis of rotation. The assembly includes a pneumatic tire mounted on a wheel. The system includes a machine for rotating and vibrating the vehicle wheel assembly in a plane parallel to an equator of the vehicle wheel assembly. The vehicle wheel assembly has a thixotropic gel disposed within an interior of the vehicle wheel assembly. The machine initiates an autobalancing mechanism provided by the thixotropic gel. The machine measures the effect achieved by the thixotropic gel on the vehicle wheel assembly and monitors whether residual imbalance exceeds a predetermined amount prior to mounting of the vehicle wheel assembly on an automobile. This is achieved by rotating the vehicle wheel assembly at an angular velocity that produces a combined vibration of the vehicle wheel assembly and hub components securing the vehicle wheel assembly to the machine.

Another aspect of the system of the present invention includes the machine having a single degree of freedom within an equatorial plane of the vehicle wheel assembly for vibrating the vehicle wheel assembly.

Another aspect of the system of the present invention includes the angular velocity being equal to the square root of spring damper rods divided by the mass of the combination of the vehicle wheel assembly and the hub components of the machine, and divided by twice π. The hub components, an “unsprung” mass, may include any components free to follow vibration excited by any imbalance. These may thereby include a hub, a part of a cardan shaft, a moving part of damper rod(s), and 50% of a spring mass. The system operates at a critical frequency (i.e., both the vibration frequency of the single degree of freedom system and the force excitation frequency created by the rotating, unbalanced vehicle wheel assembly are substantially equal).

Another aspect of the system of the present invention includes the machine further having a bearing unit and a wheel centering/clamping adaptor secured to the bearing unit. The adaptor allows the mounting of the vehicle wheel assembly to the machine.

Another aspect of the system of the present invention includes a plurality of spring/damper rods acting in an equatorial plane of the wheel for controlling vibrations horizontal damper rods for controlling large vibrations and a drive for rotating the adaptor.

### Definitions

The following definitions are controlling for the disclosed invention.

“Apex” refers to a wedge of rubber placed between the carcass and the carcass turnup in the bead area of the tire, usually used to stiffen the lower sidewall of the tire.

“Aspect ratio” of the tire means the ratio of its section height (SH) to its section width (SW) multiplied by 100% for expression as a percentage.

“Annular” means formed like a ring.

“Axial” and “axially” mean lines or directions that are parallel to the axis of rotation of the tire; synonymous with “lateral” and “laterally”.

“Bead” means that part of the tire comprising an annular tensile member wrapped by ply cords and shaped, with or without other reinforcement elements such as flippers, chippers, apexes, toe guards and chafers, to fit the design rim.

“Belt reinforcing structure” means at least two layers of plies of parallel cords, woven or unwoven, underlying the tread, unanchored to the bead, and having both left and right cord angles in the range from 17 degrees to 27 degrees with respect to the equatorial plane of the tire.

“Belt structure” means at least two annular layers or plies of parallel cords, woven or unwoven, underlying the tread, unanchored to the bead, and having both left and right cord angles in the range from 17 degrees to 27 degrees with respect to the equatorial plane of the tire.

“Bias ply tire” means a tire having a carcass with reinforcing cords in the carcass ply extending diagonally across the tire from bead core to bead core at about a 25°-50° angle with respect to the equatorial plane of the tire. Cords run at opposite angles in alternate layers.

“Breakers” refers to at least two annular layers or plies of parallel reinforcement cords having the same angle with reference to the equatorial plane of the tire as the parallel reinforcing cords in carcass plies.

“Buffed” means a procedure whereby the surface of an elastomeric tread or casing is roughened. The roughening removes oxidized material and permits better bonding.

“Building Drum” refers to a cylindrical apparatus on which tire components are placed in the building of a tire. The “Building Drum” may include apparatus for pushing beads onto the drum, turning up the carcass ply ends over the beads, and for expanding the drum for shaping the tire components into a toroidal shape.

“Carcass” means the tire structure apart from the belt structure, tread, undertread, and sidewall rubber over the plies, but including the beads.

“Casing” means the carcass, belt structure, beads, sidewalls, and all other components of the tire including a layer of unvulcanized rubber to facilitate the assembly of the tread, the tread and undertread being excluded. The casing may be new, unvulcanized rubber or previously vulcanized rubber to be fitted with a new tread.

“Center plane” means the plane perpendicular to the axis of rotation of the tread and passing through the axial center of the tread.

“Circumferential” means lines or directions extending along the perimeter of the surface of the annular tire parallel to the Equatorial Plane (EP) and perpendicular to the axial direction.

“Chafers” refers to narrow strips of material placed around the outside of the bead to protect cord plies from the rim, distribute flexing above the rim, and to seal the tire.

“Chippers” mean a reinforcement structure located in the bead portion of the tire.

“Cord” means one of the reinforcement strands of which the plies in the tire are comprised.

“Design rim” means a rim having a specified configuration and width. For the purposes of this specification, the design rim and design rim width are as specified by the industry standards in effect in the location in which the tire is made. For example, in the United States, the design rims are as specified by the Tire and Rim Association. In Europe, the rims are as specified in the European Tyre and Rim Technical Organisation—Standards Manual and the term design rim means the same as the standard measurement rims. In Japan, the standard organization is The Japan Automobile Tire Manufacturer's Association.

“Design rim width” is the specific commercially available rim width assigned to each tire size and typically is between 75 and 90% of the specific tire's section width.

“Equatorial plane (EP)” means the plane perpendicular to the tire's axis of rotation and passing through the center of its tread.

“Filament” refers to a single yarn.

“Flipper” refers to reinforcing fabric around the bead wire for strength and to tie the bead wire into the tire body.

“Footprint” means the contact patch or area of contact of the tire tread with a flat surface at zero speed and under normal load and pressure.

“Groove” means, with regard to a tread, an elongated void area in a tread that may extend circumferentially or laterally about the tread in a straight, curved, or zigzag manner. Circumferentially and laterally extending grooves sometimes have common portions. The “groove width” is equal to tread surface occupied by a groove or groove portion, the width of which is in question, divided by the length of such groove or groove portion; thus, the groove width is its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves which they interconnect, they are regarded as forming “tie bars” tending to maintain a rib-like character in the tread region involved.

“Inboard side” means the side of the tire nearest the vehicle when the tire is mounted on a wheel and the wheel is mounted on the vehicle.

“Inner” means toward the inside of the tire and “outer” means toward its exterior.

“Lateral” means an axial direction.

“Lateral edge” means the axially outermost edge of the tread as defined by a plane parallel to the equatorial plane and intersecting the outer ends of the axially outermost traction lugs at the radial height of the inner tread surface.

“Leading” refers to a portion or part of the tread that contacts the ground first, with respect to a series of such parts or portions, during rotation of the tire in the direction of travel.

“Net contact area” means the total area of ground contacting tread elements between the lateral edges around the entire circumference of the tread divided by the gross area of the entire tread between the lateral edges.

“Net-to-gross ratio” means the ratio of the tire tread rubber that makes contact with a hard flat surface while in the footprint, divided by the area of the tread in the footprint, including non-contacting portions such as grooves.

“Nominal rim diameter” means the average diameter of the rim flange at the location where the bead portion of the tire seats.

“Normal inflation pressure” refers to the specific design inflation pressure and load assigned by the appropriate standards organization for the service condition for the tire.

“Normal load” refers to the specific design inflation pressure and load assigned by the appropriate standards organization for the service condition for the tire.

“Outboard side” means the side of the tire farthest away from the vehicle when the tire is mounted on a wheel and the wheel is mounted on the vehicle.

“Pantographing” refers to the shifting of the angles of cord reinforcement in a tire when the diameter of the tire changes, e.g. during the expansion of the tire in the mold.

“Ply” means a continuous layer of rubber-coated parallel cords.

“Pneumatic tire” means a laminated mechanical device of generally toroidal shape (usually an open torus) having beads and a tread and made of rubber, chemicals, fabric and steel or other materials. When mounted on the wheel of a motor vehicle, the tire through its tread provides traction and contains the fluid or gaseous matter, usually air, that sustains the vehicle load.

“Radial” and “radially” mean directions radially toward or away from the axis of rotation of the tire.

“Section height” means the radial distance from the nominal rim diameter to the outer diameter of the tire at its equatorial plane.

“Shoulder” means the upper portion of sidewall just below the tread edge. Tread shoulder or shoulder rib means that portion of the tread near the shoulder.

“System” means any of the group comprising, but not limited to, an apparatus, a method, a device, and an article of manufacture. System is inclusive and broader than these categories of invention.

“Thixotropic gel” means a fluid that develops strength, or rigidity, over time when not subject to shearing or agitation.

“Tread Width” means the arc length of the tread surface in the axial direction, that is, in a plane parallel to the axis of rotation of the tire.

“Undertread” refers to a layer of rubber placed between a reinforcement package and the tread rubber in a tire.

“Unit tread pressure” means the radial load borne per unit area (square centimeter or square inch) of the tread surface when that area is in the footprint of the normally inflated and normally loaded tire.

“Wedge” refers to a tapered rubber insert, usually used to minimize curvature of a reinforcing component, e.g. at a belt edge.

“Wings” means the radial inward extension of the tread located at axial extremes of the tread, the inner surface of the wing being an extension of the inner casing contacting surface of the tread.

“Year-round” means a full calendar year through each season. For example, a snow tire is not designed for year-round use since it creates objectionable noise on dry road surfaces and is designed to be removed when the danger of snow is passed.

### BRIEF DESCRIPTION OF THE DRAWINGS

The invention will be described by way of example and with reference to the accompanying drawings in which:

FIG. 1 is a schematic radial view of an example tire and tire tread for use with the present invention;

FIG. 2 is a detailed schematic cross-sectional view of a section of the example tire of FIG. 1 along with a schematic representation of one example system in accordance with the present invention;

FIG. 3 is a detailed schematic cross-sectional view of a section of the example tire of FIG. 1 along with a schematic representation of another example system in accordance with the present invention;

FIG. 4 is a detailed schematic cross-sectional view of a section of the example tire of FIG. 1 along with a schematic representation of still another example system in accordance with the present invention; and

FIG. 5 is a detailed schematic view of a machine for automatically balancing a tire in accordance with the present invention.

### DETAILED DESCRIPTION OF AN EXAMPLE EMBODIMENT OF THE INVENTION

The following language is of the best presently contemplated mode or modes of carrying out an example embodiment of the invention. This description is made for the purpose of illustrating the general principals of the invention and should not be taken in a limiting sense. The scope of the invention is best determined by reference to the appended claims.

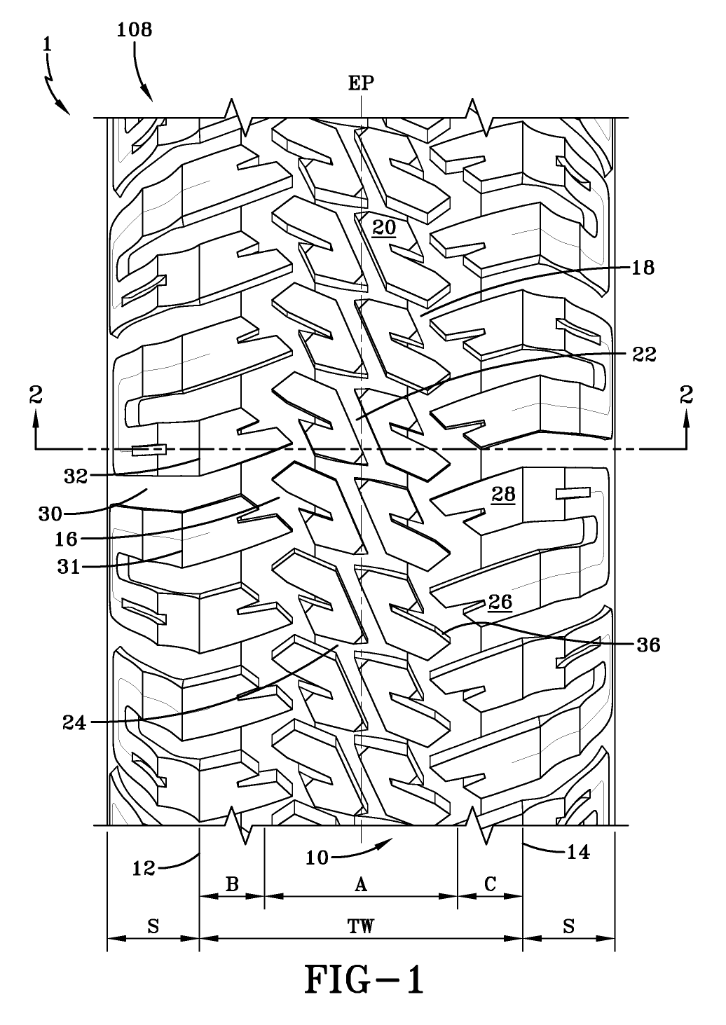

FIGS. 1-4 illustrate an example tire 1 for use with the present invention. The tire 1 has a carcass 100 that extends between, and is turned up around, a pair of opposing beads 102. The carcass 100 is also located radially outward of an innerliner 104 that extends between opposing bead toes 106. A belt structure 110 is located radially outward of the carcass 100 and radially inward of the tire tread 108. The belt structure 110 comprises multiple plies of reinforcing cords. The example tire tread 108, as illustrated, has an on-road central tread portion 10 having a tread width TW, defined by a pair of first and second lateral edges 12, 14. Axially outward of each lateral edge 12, 14 is a shoulder region S.

The central tread portion 10 is laterally divided into three tread zones, A, B, C. The central tread zone A is positioned axially between a pair of first and second circumferential grooves 16, 18. The first shoulder zone B is located between the first lateral edge 12 and the first circumferential groove 16. The second, opposite shoulder zone C is located between the second lateral edge 14 and the second circumferential groove 18. The central tread zone A has a width greater than the first and second shoulder zones B, C, while the first and second shoulder zones B, C each have the same width (FIG. 1).

The central tread zone A has a plurality of ground engaging traction elements 20 separated axially by the first and second circumferential grooves 16, 18, and a central circumferential groove 22. The plurality of ground engaging traction elements 20 are further circumferentially separated by lateral grooves 24. Each traction element 20 extends radially outwardly from a tread base 60 to an outer tread surface 62.

In each shoulder zone B, C, a plurality of ground engaging traction elements 26, 28 are separated by lateral grooves 30. The lateral grooves 30 intersect and join with the lateral grooves 24 of the central tread zone A to form an axially continuous lateral groove path across the tread width TW (FIG. 1). The traction elements 26, 28 of each shoulder zone B, C extend laterally across each shoulder zone. The traction elements 26 have a greater lateral width than the traction elements 28. The traction elements 26 extend laterally from their axially outer edges 31, coincident with the lateral edges 12, 14 of each shoulder zone B, C, axially and inwardly toward an equatorial plane EP of the tire 1. Circumferentially adjacent each longer traction element 26 is a shorter traction element 28. The shorter traction elements 28 have axially outer edges 32 spaced axially inward from the lateral edges 12, 14 of each shoulder zone B, C and the coincident axially outer edges 31 of the longer traction elements 26. The adjacent shorter traction elements 28 extend axially and inwardly toward the equatorial plane EP of the tire 1. Axially inner ends of both types of traction elements 26, 28 are axially aligned.

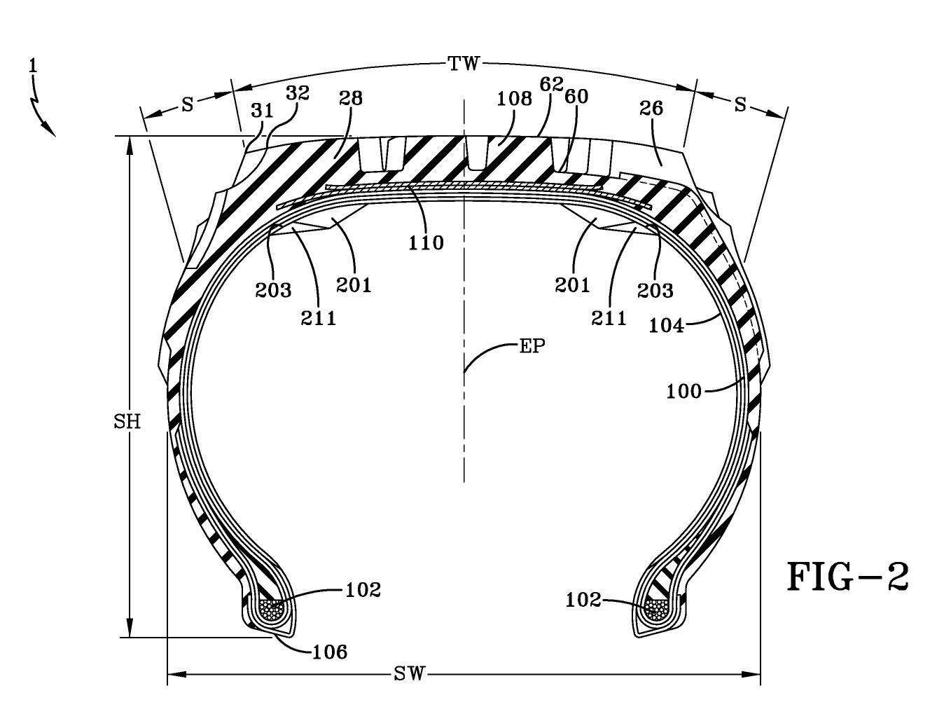

In accordance with one feature of the present invention, the example tire 1 of FIGS. 1-2 further includes an autobalancing system with an annular spacer structure comprising two annular ribs 201 attached to a radially inner surface of the innerliner 104 radially inward from the belt structure 110. The annular ribs 201 may be constructed of any suitable material and attached to the innerliner 104 at any appropriate step of tire construction. The annular ribs 201 are triangular in cross-section, have one vertex pointing radially inward, and define interior circumferential grooves 203 between the slanted axially outer sides of the ribs 201 and portions of the innerliner 104 extending radially toward the corresponding beads 102 (FIG. 2). For the example tire 1, the axially outer sides of the ribs may be approximately 100 mm apart. The circumferential grooves 203 are thus located generally radially inward of the shoulder regions S (FIG. 2).

The system further includes a thixotropic gel disposed within the circumferential grooves 203 thereby defining two circumferential gel rings 211. For the example tire 1, the amount of gel comprising each circumferential gel ring 211 may be approximately 60 grams. As stated in the definitions above, a thixotropic gel is a fluid that develops strength, or rigidity, over time when not subject to shearing or agitation. When the gel is initially applied to the grooves 203 of a generally stationary tire 1, the gel of the rings 211 is a very viscous fluid that will stay in place, or set.

When the tire 1 is installed on a wheel, on a vehicle, and the vehicle is initially operated, the tire 1 rotates and thus agitates the gel of each circumferential gel ring 211. The gel of each ring 211 automatically will flow in any direction of force until no more forces, except direct, or only radial, centripedal forces, act on it. The only way in which only centripedal forces act on the gel is for the entire tire/wheel assembly to be in a balanced state. Each subsequent rotation of the tire 1 will again yield an automatically balanced tire/wheel assembly.

Even unanticipated and undefinable future factors that may cause the tire/wheel assembly to become unbalanced, such as tire tread wear, minor damage to the tire/wheel, etc., are compensated by the automatic balancing created by the circumferential gel rings 211. The annular spacer structure 201 reduces the amount of thixotropic gel required for the balancing system and desirably limits gel flow, since more gel would necessarily flow more often and in greater quantities.

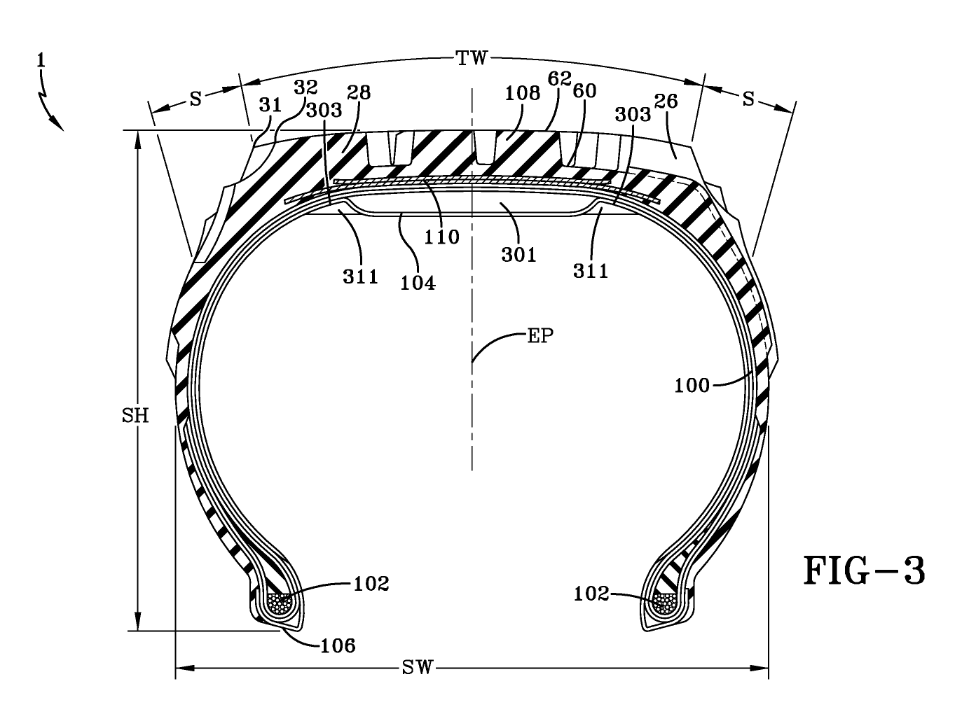

In accordance with another feature of the present invention, the example tire 1 of FIGS. 1 and 3 further includes an autobalancing system with an annular spacer structure comprising an annular spacer component 301 disposed radially between the innerliner 104 and the belt structure 110. The spacer component 301 may be constructed of any suitable material and preassembled with the other structures of the tire 1 prior to curing. The spacer component 301 may have axially opposite, tapered lateral edge portions that, along with the radially protruding innerliner 104 caused by the spacer component, define interior circumferential grooves 303 between the tapered lateral edge portions/innerliner and portions of the innerliner 104 extending radially toward the corresponding beads 102 (FIG. 3). The tapered lateral edge portions reduce in thickness as the edges portions extend axially outward away from the equatorial plane EP of the tire 1. For the example tire 1, the spacer component may have an approximately 100 mm width. The circumferential grooves 303 are thus located generally radially inward of the shoulder regions S (FIG. 3).

The system further includes a thixotropic gel disposed within the circumferential grooves 303 thereby defining two circumferential gel rings 311. For the example tire 1, the amount of gel comprising each circumferential gel ring 311 may be approximately 60 grams. As stated in the definitions above, a thixotropic gel is a fluid that develops strength, or rigidity, over time when not subject to shearing or agitation. When the gel is initially applied to the grooves 303 of a generally stationary tire 1, the gel of the rings 311 is a very viscous fluid that will stay in place, or set.

When the tire 1 is installed on a wheel, on a vehicle, and the vehicle is initially operated, the tire 1 rotates and thus agitates the gel of each circumferential gel ring 311. The gel of each ring 311 automatically will flow in any direction of force until no more forces, except direct, or only radial, centripedal forces, act on it. The only way in which only centripedal forces act on the gel is for the entire tire/wheel assembly to be in a balanced state. Each subsequent rotation of the tire 1 will again yield an automatically balanced tire/wheel assembly.

Even unanticipated and undefinable future factors that may cause the tire/wheel assembly to become unbalanced, such as tire tread wear, minor damage to the tire/wheel, tire non-uniformities generated by geometric run-out or spring rate variations, etc., are partially or completely compensated by the automatic balancing created by the circumferential gel rings 311. This occurs because the first sinusoidal waveform content, the first harmonic frequency, can excite the “wheel hop” vibration mode, which may then cause the thixotropic gel to move to a different angular location within the tire and thereby reduce vibration. The annular spacer structure 301 reduces the amount of thixotropic gel required for the balancing system and desirably limits gel flow, since more gel would necessarily flow more often and in greater quantities.

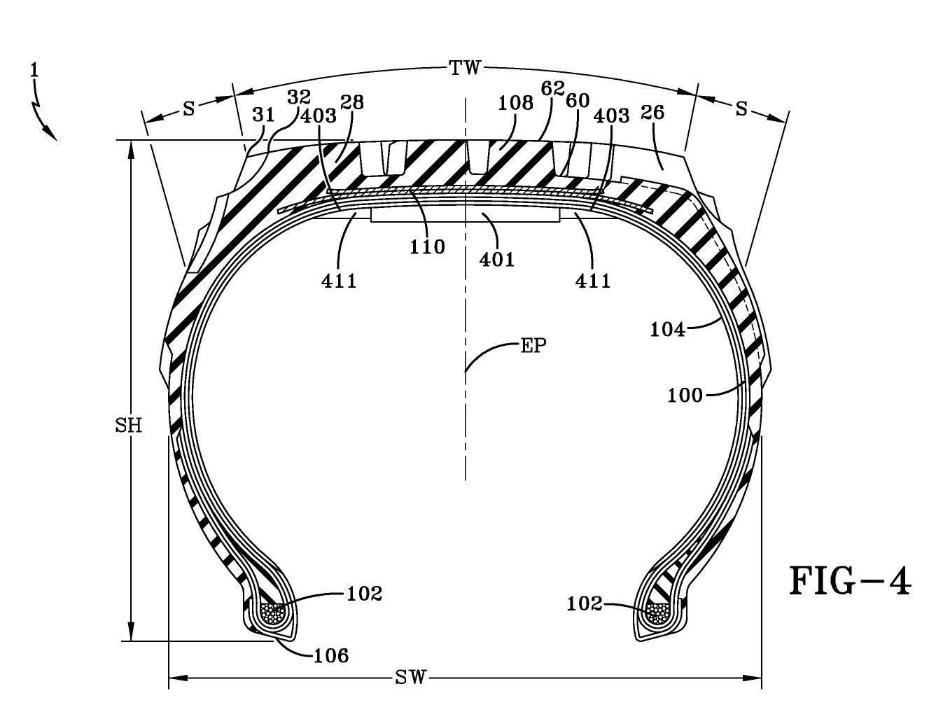

In accordance with still another feature of the present invention, the example tire 1 of FIGS. 1 and 4 further includes an autobalancing system with an annular spacer structure comprising an annular ring component 401 having a rectangular cross-section and attached to a radially inner surface of the innerliner 104. The annular ring component 401 may be constructed of any suitable material, such as foam or sponge strip, and secured to the tire 1 in any suitable manner at any appropriate step of tire construction. The annular ring component 401 defines interior circumferential grooves 403 between opposite, axially outer sides of the annular ring component 401 and portions of the innerliner 104 extending radially toward the corresponding beads 102 (FIG. 4). For the example tire 1, the axially outer sides of the annular ring component 403 may be approximately 100 mm apart and the thickness of the annular ring component may be 5 mm. The circumferential grooves 403 are thus located generally radially inward of the shoulder regions S (FIG. 4).

The system further includes a thixotropic gel disposed within the circumferential grooves 403 thereby defining two circumferential gel rings 411. For the example tire 1, the amount of gel comprising each circumferential gel ring 411 may be approximately 60 grams. As stated in the definitions above, a thixotropic gel is a fluid that develops strength, or rigidity, over time when not subject to shearing or agitation. When the gel is initially applied to the grooves 403 of a generally stationary tire 1, the gel of the rings 411 is a very viscous fluid that will stay in place, or set.

When the tire 1 is installed on a wheel, on a vehicle, and the vehicle is initially operated, the tire 1 rotates and thus agitates the gel of each circumferential gel ring 411. The gel of each ring 411 automatically will flow in any direction of force until no more forces, except direct, or only radial, centripedal forces, act on it. The only way in which only centripedal forces act on the gel is for the entire tire/wheel assembly to be in a balanced state. Each subsequent rotation of the tire 1 will again yield an automatically balanced tire/wheel assembly.

Even unanticipated and undefinable future factors that may cause the tire/wheel assembly to become unbalanced, such as tire tread wear, minor damage to the tire/wheel, etc., are compensated by the automatic balancing created by the circumferential gel rings 411. The annular spacer structure 401 reduces the amount of thixotropic gel required for the balancing system and desirably limits gel flow, since more gel would necessarily flow more often and in greater quantities.

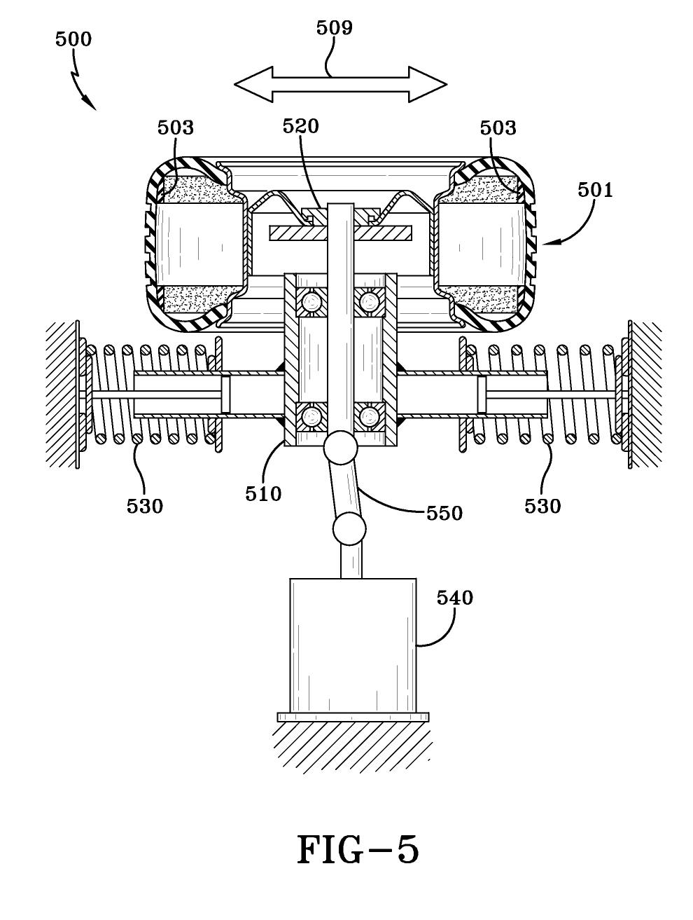

In accordance with another aspect of the present invention, FIG. 5 schematically illustrates a machine 500 for initiating the autobalancing mechanism provided by the thixotropic gel. The machine 500 may monitor and measure the effect achieved by the thixotropic gel on a tire/wheel assembly prior to mounting of the tire/wheel assembly on an automobile. The machine 500 provides for the mounting of a free spinning tire/wheel assembly. The machine 500 may have at least one degree of freedom, typically a vertical degree of freedom. The machine 500 may thereby simulate vibrations of an automobile when a “wheel hop” vibration mode is created by free rotational forces.

In FIG. 5, the machine 500 includes a bearing unit 510 and a wheel centering and clamping adaptor 520 secured to the bearing unit. The adaptor 520 allows the mounting of a tire/wheel assembly 501 to the machine 500. The machine 500 further includes a plurality of horizontal spring/damper rods 530 (two shown) for limiting/controlling large vibrations and an electrical drive 540 for rotating the adaptor 520 through a cardan shaft 550. The spring/damper rods 530 and the electrical drive may be anchored to a frame of the machine 500 or another suitable stationary location. Additional damper rods (not shown) may be added to the machine 500 for other degrees of freedom, where appropriate.

The arrow 509 illustrates a vibration introduced by an imbalance of the tire/wheel assembly 501. This imbalance may cause thixotropic gel 503 (as described above) to redistribute within the tire thereby reducing the imbalance to a negligible amount. Optimally, in order to cause a maximum vibration in the machine 500, the machine may rotate the tire/wheel assembly 501 at an angular velocity that produces a vibration frequency of the machine and tire/wheel assembly combination.

This may be calculated as the square root of the spring rate of the machine/tire/wheel divided by the mass of the machine/tire/wheel, and divided by twice π. Thus, the machine 500 is operated at its critical frequency. For a second degree of freedom, the same the angular velocity may be calculated by the same calculation as for a single degree of freedom. The calculation of this “critical” angular velocity may set a range of plus or minus 30%. A machine operating outside of this range will be relatively inefficient, since vibration displacement would be too small to transmit a significant shear force to the thixotropic gel.

As stated above, the spring/damper rods 530 prevent destruction of the machine 500. Alternatively, physically separate spring and dampers (not shown) may be utilized instead of the spring/damper rods 530.

What is claimed is:

1. A pneumatic tire comprising an axis of rotation, a belt structure, an innerliner disposed radially inward of the belt structure, and two annular beads for securing the tire to a wheel, the tire comprising:
an annular spacer structure attached to the innerliner and being disposed radially inward of the belt structure, the annular spacer structure defining two interior circumferential grooves between axially outer sides of the annular spacer structure and portions of the innerliner extending radially inward toward the corresponding beads of the tire; and
a thixotropic gel disposed within the circumferential grooves thereby defining two circumferential gel rings, the gel of each circumferential gel ring automatically, upon rotation of the tire, flowing until no more forces, except direct centripedal forces, act on the gel such that the tire is rotationally balanced.

2. The pneumatic tire of claim 1 further characterized in that the annular spacer structure comprises two annular ribs attached to a radially inner surface of the innerliner.

3. The pneumatic tire of claim 1 further characterized in that the annular spacer structure comprises two ribs having triangular cross-sections.

4. The pneumatic tire of claim 1 further characterized in that the annular spacer structure comprises two separate ribs each having a slanted axially outer side partially defining each of the two circumferential grooves.

5. The pneumatic tire of claim 1 further characterized in that the annular spacer structure comprises an annular spacer component disposed between the belt structure and the innerliner.

6. The pneumatic tire of claim 1 further characterized in that the annular spacer structure has two axially opposite and tapered edge portions.

7. The pneumatic tire of claim 1 further characterized in that the annular spacer structure comprises an annular ring component attached to a radially inner surface of the innerliner.

8. The pneumatic tire of claim 1 further characterized in that the annular spacer structure comprises an annular ring component having a rectangular cross-section, the annular ring component extending axially between the axially outer sides of the annular spacer structure.

9. A method for balancing a pneumatic tire with an axis of rotation, the method comprising the steps of:
securing an annular spacer structure adjacent an innerliner of the tire at a position radially inward of a belt structure of the tire;
defining two interior circumferential grooves between axially outer sides of the annular spacer structure and portions of the innerliner extending radially inward toward corresponding beads of the tire;
applying a thixotropic gel within the circumferential grooves thereby defining two circumferential gel rings; and
rotating the tire such that the gel of each circumferential gel ring automatically flows until no more forces, except direct centripedal forces, act on the gel and the tire is rotationally balanced.

10. The method of claim 9 further comprising the step of attaching two annular ribs to a radially inner surface of the innerliner.

11. The method of claim 9 further comprising the step of providing the annular spacer structure with two separate ribs each having a slanted axially outer side partially defining each of the two circumferential grooves.

12. The method of claim 9 further comprising the step of positioning an annular spacer component between the belt structure and the innerliner.

13. The method of claim 9 further comprising the step of attaching an annular ring component to a radially inner surface of the innerliner.

14. A system for automatically balancing a pneumatic tire upon rotation of the tire about an axis of rotation, the system comprising:
an annular spacer structure secured to an innerliner of the tire at a position radially inward of a belt structure of the tire, the annular spacer structure defining two interior circumferential grooves between axially outer sides of the annular spacer structure and portions of an innerliner extending radially inward toward corresponding beads of the tire; and
a thixotropic gel disposed within the circumferential grooves thereby defining two circumferential gel rings, the gel of each circumferential gel ring automatically flowing in any direction of force until no more forces, except direct centripedal forces, act on the gel and the tire is rotationally balanced.

15. The system of claim 14 further comprising an annular ring component attached to a radially inner surface of the innerliner.

16. A system for automatically balancing a pneumatic tire upon rotation of the tire about an axis of rotation, the system comprising:
a tire and wheel assembly having a thixotropic gel disposed within an interior of the tire and wheel assembly,
a machine for rotating and vibrating the tire and wheel assembly in a plane parallel to an equator of the tire and wheel assembly, the machine initiating an autobalancing mechanism provided by the thixotropic gel, the machine monitoring and measuring the effect achieved by the thixotropic gel on the tire and wheel assembly prior to mounting of the tire and wheel assembly on an automobile,
the machine rotating the tire and wheel assembly at an angular velocity that produces a combined vibration frequency of the tire and wheel assembly and the machine.

17. The system of claim 16 wherein the angular velocity equals the square root of a spring rate of a combination of the tire and wheel assembly and the machine divided by the mass of the combination of the tire and wheel assembly and the machine, and divided by twice π.

18. The system of claim 16 wherein the machine has a single vertical degree of freedom for vibrating the tire and wheel assembly.

19. The system of claim 16 wherein the machine further includes a bearing unit and a wheel centering and clamping adaptor secured to the bearing unit, the adaptor allowing the mounting of the tire and wheel assembly to the machine.

20. The system of claim 19 wherein the machine further includes a plurality of horizontal damper rods for controlling large vibrations and a drive for rotating the adaptor.
